(19) United States
(12) Patent Application Publication
(10) Pub. No.: US 2024/0203447 A1
(43) Pub. Date: Jun. 20, 2024

(54) INFORMATION PROCESSING DEVICE AND NON-TRANSITORY COMPUTER-READABLE MEDIUM STORING INFORMATION PROCESSING PROGRAM

(71) Applicant: TOYOTA JIDOSHA KABUSHIKI KAISHA, Toyota-shi Aichi-ken (JP)

(72) Inventor: Ryosuke TACHIBANA, Shinagawa-ku Tokyo-to (JP)

(73) Assignee: TOYOTA JIDOSHA KABUSHIKI KAISHA, Toyota-shi Aichi-ken (JP)

(21) Appl. No.: 18/522,672

(22) Filed: Nov. 29, 2023

(30) Foreign Application Priority Data
Dec. 20, 2022 (JP) 2022-203675

(51) Int. Cl. G10L 25/63; G10L 25/27

(52) U.S. Cl. CPC G10L 25/63; G10L 25/27

(57) ABSTRACT

An information processing device including: a memory; and a processor coupled to the memory, the processor being configured to: acquire one piece of audio data of a user, extract plural pieces of audio data that have been extracted during a predetermined time period from the one piece of audio data, the plural pieces of audio data being extracted by moving the time period by a predetermined unit time, estimate respective feature amounts indicating an emotion of the user from each of the plural pieces of audio data, by using an estimation model obtained by executing machine learning for estimating feature amounts indicating an emotion of the user from the plural pieces of audio data that have been extracted, and determine the emotion of the user indicated by the one piece of audio data, by using the respective feature amounts corresponding to the plural pieces of audio data.

### CROSS-REFERENCE TO RELATED APPLICATION

This application claims priority under 35 USC 119 from Japanese Patent Application No. 2022-203675, filed on Dec. 20, 2022, the disclosure of which is incorporated by reference herein.

### BACKGROUND

### Technical Field

The present disclosure relates to an information processing device and a non-transitory computer-readable medium storing an information processing program that estimate an emotion from audio data.

### Related Art

Japanese Patent Application Laid-Open (JP-A) No. 2022-079446, discloses a trauma screening device that converts audio data to image data as pre-processing, and performs machine learning using the image data as learning data, to estimate an emotion from the audio data. The trauma screening device according to Japanese Patent Application Laid-Open (JP-A) No. 2022-079446, is characterized in that, in a case in which plural pieces of image data per a predetermined time period are generated from one piece of image data converted by the preprocessing, the image data is amplified by performing shifting by a predetermined time unit to extract the plural pieces of image data.

In a case in which a feature such as an emotion or the like is estimated from audio data using the technology of Japanese Patent Application Laid-Open (JP-A) No. 2022-079446, different features may be estimated in each of the plural pieces of data that have been extracted. Therefore, in a case in which plural pieces of data are extracted from one piece of audio data, the feature represented by the audio data cannot always be accurately estimated.

### SUMMARY

The present disclosure provides an information processing device and a non-transitory computer-readable medium storing an information processing program that are capable of accurately estimating a feature represented by audio data in a case in which plural pieces of data are extracted from one piece of audio data.

A first aspect of the present disclosure is an information processing device including: a memory; and a processor coupled to the memory, the processor being configured to: acquire one piece of audio data of a user, extract plural pieces of audio data that have been extracted during a predetermined time period from the one piece of audio data, the plural pieces of audio data being extracted by moving the time period by a predetermined unit time, estimate respective feature amounts indicating an emotion of the user from each of the plural pieces of audio data, by using an estimation model obtained by executing machine learning for estimating feature amounts indicating an emotion of the user from the plural pieces of audio data that have been extracted, and determine the emotion of the user indicated by the one piece of audio data, by using the respective feature amounts corresponding to the plural pieces of audio data.

The information processing device according to the first aspect of the present disclosure acquires the one piece of audio data of the user, moves the predetermined time period, which serves as an extraction range, per the predetermined unit time, to extract the plural pieces of audio data from the one piece of audio data, uses the estimation model obtained by executing machine learning for estimating the emotion of the user from audio data, to estimate the feature amounts indicating the emotion from each of the plural pieces of audio data that have been extracted, and uses the plural feature amounts that have been estimated, to determine the emotion of the user indicated by the one piece of audio. Consequently, in a case in which plural pieces of data are extracted from one piece of audio data, a feature indicated by the audio data may be accurately estimated.

In a second aspect of the present disclosure, in the first aspect, the predetermined time period may be set according to, in the one piece of audio data that has been previously acquired: feature amounts indicating an emotion that corresponds to an emotion of the user that has been set as a label of the one piece of audio data, and feature amounts indicating an emotion that is different from the emotion of the user that has been set as the label of the one piece of audio data.

According to the information processing device according to the second aspect of the present disclosure, in a case in which one piece of audio data includes features that are different from a feature indicated by the one piece of audio data overall, influence of the features that are different from the feature indicated by the audio data may be suppressed.

In a third aspect of the present disclosure, in the first aspect or the second aspect, the processor may be configured to extract the plurality of pieces of audio data by setting the unit time, such that a number of pieces of the audio data extracted from the one piece of audio data is a predetermined number.

According to the information processing device according to the third aspect of the present disclosure, the emotion of the user may be accurately estimated regardless of a length of the acquired audio data.

In a fourth aspect of the present disclosure, in any one of the first aspect to the third aspect, the processor may be configured to: estimate the respective feature amounts indicating the emotion of the user, using, as the estimation model, an individual user estimation model obtained by learning one piece of audio data for each individual user among a plurality of users, and an overall user estimation model obtained by learning one piece of audio data related to all of the plurality of users, and determine the emotion of the user indicated by the one piece of audio data, using feature amounts that have respectively been estimated by the individual user estimation model and the overall user estimation model.

According to the information processing device according to the fourth aspect of the present disclosure, the emotion of the user may be estimated more accurately than in a case in which the estimation is performed using one of the individual user estimation model or the overall user estimation model.

A fifth aspect of the present disclosure is a non-transitory computer-readable medium storing an information processing program that is executable by a computer to perform processing comprising: acquiring one piece of audio data of a user; extracting a plurality of pieces of audio data that have been extracted during a predetermined time period from the one piece of audio data, the plurality of pieces of audio data being extracted by moving the time period by a predetermined unit time: estimate respective feature amounts indicating an emotion of the user from each of the plurality of pieces of audio data, by using an estimation model obtained by executing machine learning for estimating feature amounts indicating an emotion of the user from the plurality of pieces of audio data that have been extracted; and determine the emotion of the user indicated by the one piece of audio data, by using the respective feature amounts corresponding to the plurality of pieces of audio data.

A computer that executes the information processing program according to the fifth aspect of the present disclosure acquires the one piece of audio data of the user, moves the predetermined time period, which serves as an extraction range, per the predetermined unit time, to extract the plural pieces of audio data from the one piece of audio data, uses the estimation model obtained by executing machine learning for estimating the emotion of the user from audio data, to estimate the feature amounts indicating the emotion from each of the plural pieces of audio data that have been extracted, and uses the plural feature amounts that have been estimated, to determine the emotion of the user indicated by the one piece of audio. Consequently, in a case in which plural pieces of data are extracted from one piece of audio data, a feature indicated by the audio data may be accurately estimated.

According to the above-described aspects, the information processing device and the non-transitory computer-readable medium storing an information processing program of the present disclosure can accurately estimate a feature indicated by audio data in a case in which plural pieces of data are extracted from one piece of audio data.

### BRIEF DESCRIPTION OF THE DRAWINGS

Exemplary embodiment will be described in detail based on the following figures, wherein:

FIG. 1 is a diagram illustrating a schematic configuration of an information processing system according to the present exemplary embodiment;

FIG. 2 is a block diagram illustrating a hardware configuration of a center server of the present exemplary embodiment;

FIG. 3 is a block diagram illustrating a functional configuration of the center server of the present exemplary embodiment;

FIG. 4 is a data flow diagram provided for explanation of processing for estimating an emotion of the present exemplary embodiment;

FIG. 5 is a schematic diagram provided for explanation of a window size and a frame shift of the present exemplary embodiment;

FIG. 6 is a schematic diagram provided for explanation of feature amounts included in audio data of the present exemplary embodiment;

FIG. 7 is a flowchart illustrating a flow of processing for estimating an emotion that is executed in the center server of the present exemplary embodiment; and

FIG. 8 is a flowchart illustrating a flow of processing for generating an estimation model that is executed in the center server of the present exemplary embodiment.

### DETAILED DESCRIPTION

Explanation follows regarding an information processing system including an information processing device of the present disclosure. The information processing system is a system that estimates an emotion of a user using audio data of the user that has been acquired from a terminal used by the user.

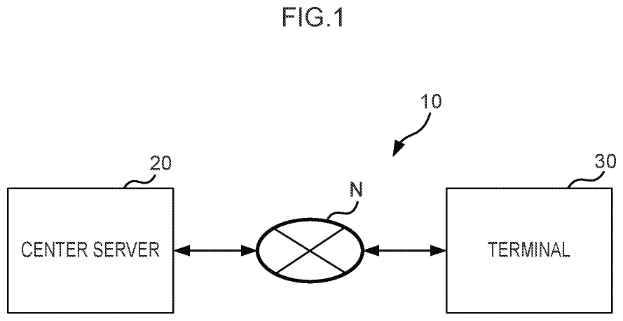

As illustrated in FIG. 1, an information processing system 10 of an exemplary embodiment of the present disclosure is configured to include a center server 20 serving as the information processing device, and a terminal 30 operated by the user. The center server 20 and the terminal 30 are connected to each other through a network N.

It should be noted that, although FIG. 1 illustrates one terminal 30 with respect to one center server 20, the numbers of the center server 20 and the terminal 30 are not limited thereto.

The center server 20 is a device that acquires audio data of the user from the terminal 30 and estimates an emotion of the user represented by the acquired audio data. It should be noted that, although explanation has been given regarding an example in which the information processing device according to the present exemplary embodiment is a center server, there is no limitation thereto. The information processing device may be a personal computer such as a terminal, a portable terminal, a tablet or the like.

The terminal 30 is an onboard terminal installed at a vehicle, a portable terminal possessed by the user, a tablet terminal, or the like, that is provided with functionality to store audio uttered by the user and transmit this audio as audio data to the center server 20.

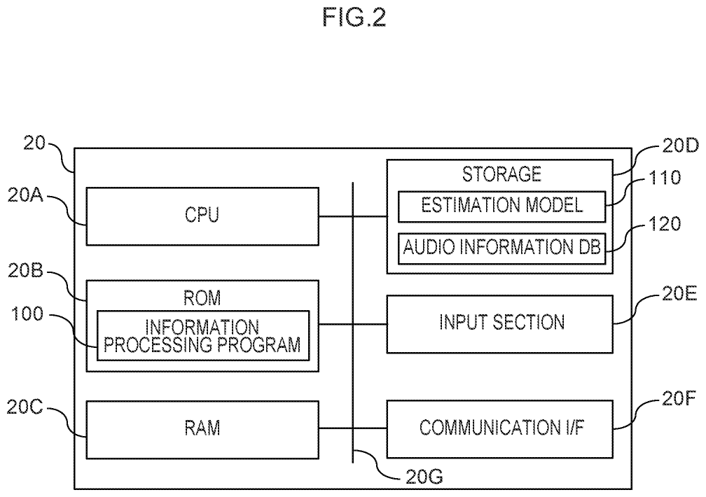

FIG. 2 is a block diagram illustrating an example of a hardware configuration of the center server 20 according to the present exemplary embodiment.

As illustrated in FIG. 2, the center server 20 according to the present exemplary embodiment is configured to include a central processing unit (CPU) 20A, a read only memory (ROM) 20B, a random access memory (RAM) 20C, a storage 20D, an input section 20E, and a communication I/F 20F. The CPU 20A, the ROM 20B, the RAM 20C, the storage 20D, the input section 20E, and the communication I/F 20F are connected so as to be capable of communicating with each other via an internal bus 20G.

The CPU 20A is a central processing unit, and the CPU 20A executes various programs and controls various sections. Namely, the CPU 20A reads programs from the ROM 20B and the storage 20D, and executes the programs using the RAM 20C as a workspace.

The ROM 20B stores various programs and various data. The ROM 20B of the present exemplary embodiment stores an information processing program 100 that estimates an emotion from audio data that has been acquired from the terminal 30. Accompanying execution of the information processing program 100, the center server 20 executes various processing including processing for acquiring the audio data from the terminal 30 and for estimating an emotion from the audio data. The RAM 20C serves as a workspace to temporarily store programs and data.

The storage 20D is, for example, a hard disk drive (HDD), a solid state drive (SSD), a flash memory, or the like. The storage 20D stores audio data of the user, a learned model, various programs, and the like. The storage 20D according to the present exemplary embodiment stores an estimation model 110 serving as the learned model, and an audio information database (hereafter referred to as the “audio information DB”) 120 in which audio data is stored.

The input section 20E is a pointing device, a keyboard, and the like that receive input of characters and execution instructions for processing.

The communication I/F 20F is a communication module for communicating with the terminal 30. For example, a communication standard such as 5G, LTE, Wi-Fi (registered trademark) or the like is used for the communication module. The communication I/F 20F is connected to the network N. It should be noted that the communication I/F 20F may perform wired communication.

The information processing program 100, serving as a program, is a program for controlling the center server 20. Accompanying execution of the information processing program 100, the center server 20 executes various processing including processing for acquiring audio data and processing for estimating an emotion of the user from the audio data.

The estimation model 110 is a learned model generated by performing machine learning for estimating an emotion of a user from audio data. The estimation model 110 estimates and outputs, with respect to audio data that has been input, the emotion of the user represented by the audio data. It should be noted that a decision tree model, a k-means method, a support vector machine (SVM) model, or the like can be applied as the estimation model 110 according to the present exemplary embodiment.

The audio information DB 120 stores audio data that has been acquired in the past.

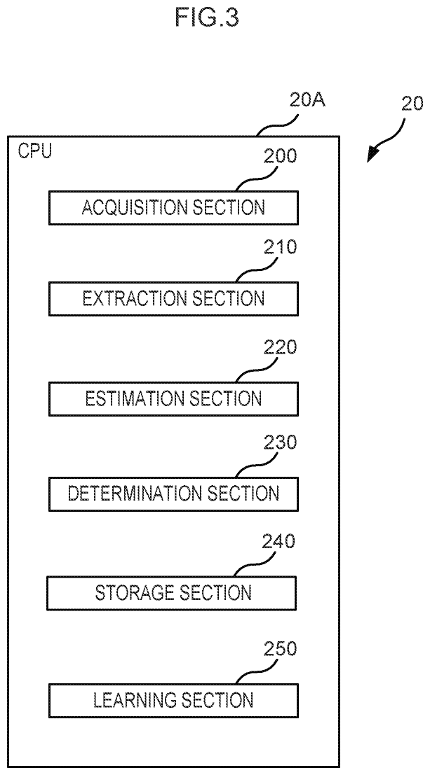

As illustrated in FIG. 3, in the center server 20 of the present exemplary embodiment, the CPU 20A executes the information processing program 100, to thereby function as an acquisition section 200, an extraction section 210, an estimation section 220, a determination section 230, a storage section 240, and a learning section 250.

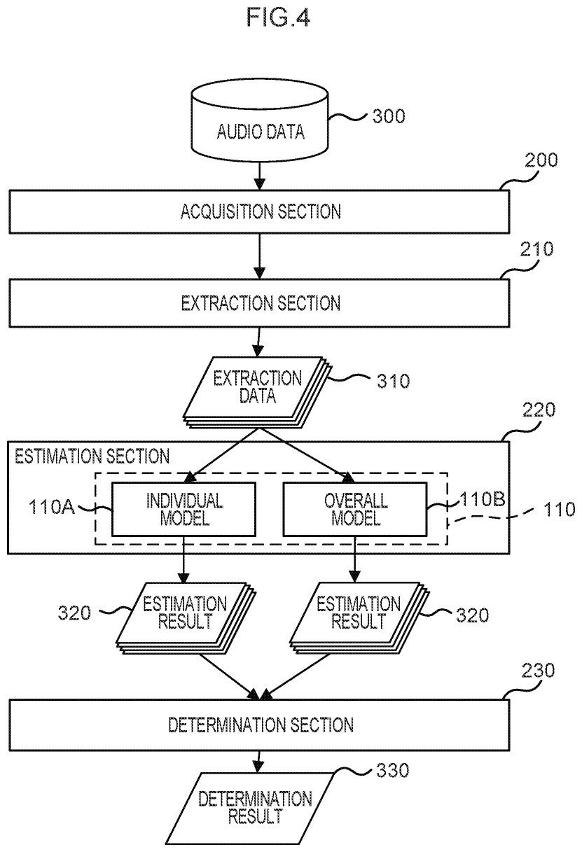

As illustrated in FIG. 4, as an example, the acquisition section 200 has a function of acquiring audio data 300 of the user that has been transmitted from the terminal 30.

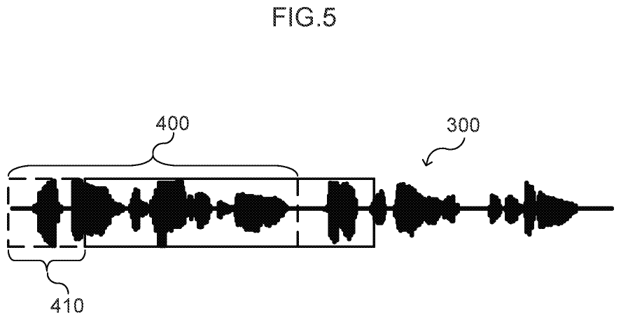

The extraction section 210 has a function of extracting extraction data 310 from the acquired audio data 300. More specifically, the extraction section 210 extracts a predetermined number (hereafter referred to as the “number of fragments”) of fragment data from the acquired audio data 300 as the extraction data 310. As shown in FIG. 5 as an example, the extraction section 210 extracts the extraction data 310 according to the number of fragments from the audio data 300, in accordance with a window size 400 and a frame shift 410. In this regard, the window size 400 is an example of a “predetermined time period”, and the frame shift 410 is an example of a “predetermined unit time”.

The window size 400 is a time period of data extracted as the extraction data 310 from the audio data 300. For example, in a case in which the window size 400 is set to 2 seconds, the extraction section 210 extracts the extraction data 310 of 2 seconds from the audio data 300.

Further, the frame shift 410 is a size by which a start position and an end position for extracting the extraction data 310 are shifted (moved) when extracting plural pieces of the extraction data 310 from the audio data 300. For example, in a case in which the frame shift 410 is set to 0.1 seconds, when extracting the extraction data 310 from the audio data 300, the extraction section 210 extracts the respective extraction data 310 while shifting (moving) the start position and the end position by 0.1 seconds each. It should be noted that the size of the frame shift 410 is set in accordance with a size of the audio data 300, the number of fragments, and a size of the window size 400. For example, in a case in which the audio data 300 is 20 seconds, the number of fragments is 100, and the window size 400 is 2 seconds, the extraction section 210 sets the frame shift 410 to 0.18 seconds, and extracts 100 pieces of the extraction data 310 of 2 seconds shifted every 0.18 seconds.

It should be noted that the size of the window size 400 is set in accordance with the learning data that has been learned. For example, even if “positive” is set as a label in the audio data 300, an emotion other than “positive” (for example, an emotion such as “negative”, “intermediate” or the like) may be included in a portion thereof. The size of the window size 400 is set, for example, so as to correspond to a time period of data indicating an emotion other than “positive” included in the audio data for which the label “positive” has been set, during a learning phase.

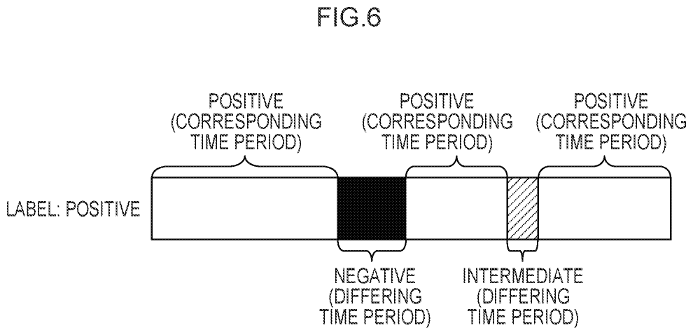

As illustrated in FIG. 6 as an example, the audio data 300 for which the label “positive” is set includes time periods indicating “positive” (an emotion corresponding to the emotion that has been set in the label) (hereafter referred to as “corresponding time periods”) and time periods indicating an emotion other than “positive” (an emotion that is different from the emotion that has been set in the label) (hereafter referred to as “differing time periods”).

The window size 400 is set to be larger than a largest time period among the differing time periods, and is set to be smaller than a smallest time period among the corresponding time periods. Consequently, the number of the extraction data 310 including an emotion that is different from the set label is suppressed when extracting plural pieces of the extraction data 310 from the audio data 300, and an influence on a determination by majority decision in the determination section 230, which will be described later, is suppressed. It should be noted that the largest time period of the differing periods according to the present exemplary embodiment is a time period that is smaller than the shortest time period of the corresponding time periods.

The estimation section 220 has a function of estimating an emotion of a user indicated by the extraction data 310 using the estimation model 110. In this regard, the estimation model 110 according to the present exemplary embodiment includes an individual model 110A that has learned the audio data 300 for each individual user, and an overall model 110B that has learned the audio data 300 for all users. In this regard, the individual model 110A is an example of an “individual user estimation model”, and the overall model 110B is an example of an “overall user estimation model”.

The estimation section 220 uses the individual model 110A and the overall model 110B to estimate a respective emotion of the user as an estimation result 320 for each of the extraction data 310.

The determination section 230 has a function of using the estimation results 320 estimated by the estimation section 220 to determine and output the emotion of the user indicated by the audio data 300 as a determination result 330. More specifically, the determination section 230 carries out a majority decision using each estimation result 320 that has been estimated with respect to the plural pieces of the extraction data 310, and determines the emotion that has been indicated most frequently as being the emotion indicated by the audio data 300.

In this regard, the determination section 230 integrates the estimation result 320 estimated by the individual model 110A and the estimation result 320 estimated by the overall model 110B with respect to one piece of the extraction data 310, and carries out determination thereof as one estimation result 320. For example, the determination section 230 respectively weights corresponding estimation results 320 among the plural estimation results 320 estimated by the individual model 110A and the plural estimation results 320 estimated by the overall model 110B, and carries out determination by integrating the corresponding estimation results 320. It should be noted that, although explanation has been given regarding an example in which the respective estimated estimation results 320 are weighted and integrated in the present exemplary embodiment, there is no limitation thereto. The estimated estimation results 320 may be averaged and integrated.

The storage section 240 has a function of storing the acquired audio data 300 in the audio information DB 120. In this regard, a label is set for the stored audio data, and the audio data is stored as learning data. The label that is set may be set by the user, or the determination result determined by the determination section 230 may be set as the label. Further, the audio data 300 may be stored in association with a feature of the user.

The learning section 250 has a function of executing machine learning using the audio data 300 that has been acquired in the past, as learning data, and generating the individual model 110A and the overall model 110B as the estimation model 110.

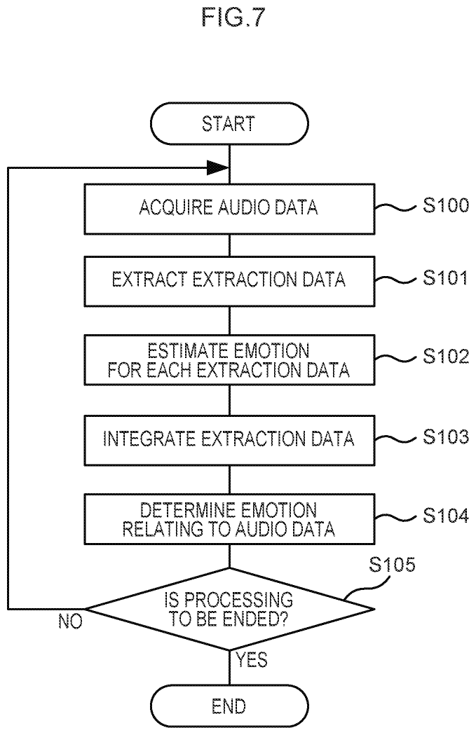

Explanation follows regarding a flow of respective processing executed by the information processing system 10 of the present exemplary embodiment, with reference to the flowchart of FIG. 7. The respective processing in the center server 20 is executed by the CPU 20A of the center server 20 functioning as the acquisition section 200, the extraction section 210, the estimation section 220, the determination section 230, the storage section 240, and the learning section 250. The processing for estimating the emotion of the user illustrated in FIG. 7 is executed in a case in which, for example, the audio data 300 has been input and an instruction to estimate the emotion of the user has been input.

At step S100, the CPU 20A acquires the audio data 300 that has been input from the terminal 30.

At step S101, the CPU 20A extracts plural pieces of the extraction data 310 from the acquired audio data 300.

At step S102, the CPU 20A estimates the emotion of the user for each of the extracted extraction data 310. In this regard, the CPU 20A inputs one piece of the extraction data 310 to the individual model 110A and the overall model 110B, and obtains the estimation result 320 from each of the individual model 110A and the overall model 110B. Further, the CPU 20A selects the estimation model 110 corresponding to the user related to the input audio data 300, as the individual model 110A, to estimate the emotion.

At step S103, the CPU 20A respectively integrates the corresponding estimation results 320 in the plural estimation results 320 estimated by the individual model 110A and the plural estimation results 320 estimated by the overall model 110B, and outputs the estimation result 320 for each of the extraction data 310.

At step S104, the CPU 20A carries out a majority decision using the plural integrated estimation results 320, determines the most frequent emotion as being the emotion of the user in the audio data 300, and outputs the determined emotion.

At step S105, the CPU 20A determines whether or not to end the processing for estimating the emotion of the user. In a case in which the processing for estimating the emotion of the user is to be ended (step S105: YES), the CPU 20A ends the processing for estimating the emotion of the user. On the other hand, in a case in which the processing for estimating the emotion of the user is not to be ended (step S105: NO), the CPU 20A transitions to step S100, and acquires the audio data 300 that has been input.

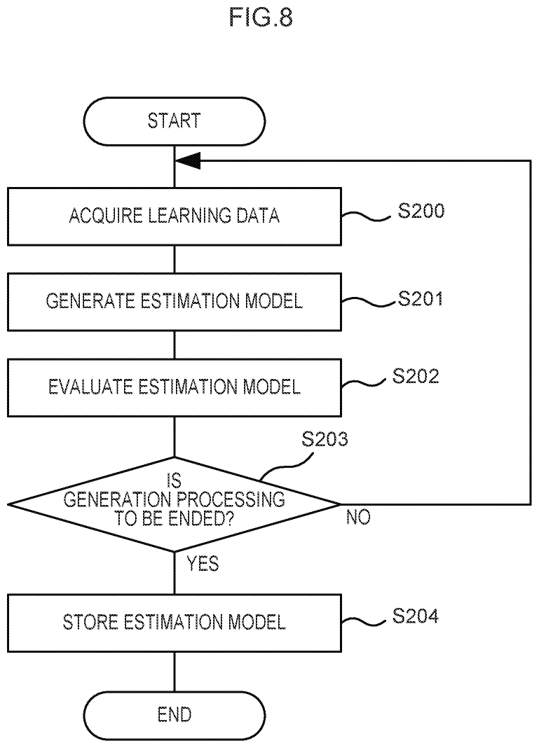

Next, explanation follows regarding processing executed by the information processing system 10 of the present exemplary embodiment for generating a learned model, with reference to the flowchart of FIG. 8. The generation processing illustrated in FIG. 8 is executed, for example, in a case in which an instruction to execute the processing for generating the learned model has been input.

At step S200, the CPU 20A acquires the audio data 300 that has been acquired in the past, as learning data.

At step S201, the CPU 20A executes machine learning using the acquired learning data to generate the estimation model 110. In this regard, the CPU 20A generates the individual model 110A using the audio data 300 for each user, and generates the overall model 110B using the audio data 300 related to all users, as the estimation model 110.

At step S202, the CPU 20A inputs the audio data 300 to the generated estimation model 110, and evaluates the estimation model 110 using the emotions of the user output from the estimation model 110.

At step S203, the CPU 20A determines whether or not to end the processing for generating the estimation model 110. In a case in which the processing for generating the estimation model 110 is to be ended (step S203: YES), the processing transitions to step S204. On the other hand, in a case in which the processing for generating the estimation model 110 is not to be ended (step S203: NO), the CPU 20A transitions to step S200, and acquires the learning data.

At step S204, the CPU 20A stores the generated estimation model 110.

The center server 20 serving as the information processing device of the present exemplary embodiment: acquires one piece of audio data of a user; extracts plural pieces of audio data from the one piece of audio data by moving an extraction range of a predetermined time period per a predetermined unit time: estimates a feature amount indicating an emotion from each of the extracted plural pieces of audio data using an estimation model that has been obtained by executing machine learning for estimating an emotion of a user from audio data; and determines the emotion of the user indicated by the one piece of audio using the estimated plural feature amounts.

As described above, according to the present exemplary embodiment, in a case in which plural pieces of data are extracted from one piece of audio data, the feature indicated by the audio data may be accurately estimated.

It should be noted that, although explanation has been given, in the above-described exemplary embodiment, regarding an example in which the window size 400 is set to be larger than the largest time period among the differing time periods and set to be smaller than the smallest time period among the corresponding time periods, there is no limitation thereto.

The window size 400 may be set so as to be smaller than the largest time period of the differing time periods, or may be set so as to be larger than the smallest time period of the corresponding time periods.

Further, although explanation has been given regarding an example in which the individual model 110A according to the above-described exemplary embodiment learns the audio data 300 for each user, there is no limitation thereto. Audio data for each feature of the user may be learned. For example, the individual model 110A may be generated by associating and storing user features such as gender, age, height, weight and the like, as features of the users, with the audio data 300, and executing machine learning using the audio data 300 related to similar features as learning data. Further, in a case in which the individual model 110A is selected, the individual model 110A may be selected using the features of the user that have been associated with the audio data 300.

It should be noted that the various processing executed by the CPU 20A reading and executing software (a program) in the above-described exemplary embodiment may be executed by various types of processors other than a CPU. Such processors include programmable logic devices (PLD) that allow circuit configuration to be modified post-manufacture, such as a field-programmable gate array (FPGA) or the like, and dedicated electric circuits, which are processors including a circuit configuration that has been custom-designed to execute specific processing, such as an application specific integrated circuit (ASIC) or the like. Further, the respective processing described above may be executed by any one of these various types of processors, or may be executed by a combination of two or more of the same type or different types of processors (such as, for example, plural FPGAs, a combination of a CPU and an FPGA, or the like). Furthermore, the hardware structure of these various types of processors is, more specifically, an electric circuit combining circuit elements such as semiconductor elements or the like.

Further, in the above-described exemplary embodiment, explanation has been given regarding an example in which the respective programs are stored (installed) in advance in a non-transitory recording medium that is readable by a computer. For example, the information processing program 100 in the center server 20 is stored in advance in the ROM 20B. However, there is no limitation thereto, and the respective programs may be provided in a format recorded on a non-transitory recording medium such as a compact disc read only memory (CD-ROM), a digital versatile disc read only memory (DVD-ROM), a universal serial bus (USB) memory, or the like. Alternatively, the programs may be provided in a format downloadable from an external device via a network.

The flow of processing explained in the above-described exemplary embodiment is an example, and unnecessary steps may be excluded, new steps may be added, or the processing order may be rearranged, within a range that does not depart from the spirit of the present disclosure.

What is claimed is:

1. An information processing device comprising:
a memory; and
a processor coupled to the memory, the processor being configured to:
acquire one piece of audio data of a user,
extract a plurality of pieces of audio data that have been extracted during a predetermined time period from the one piece of audio data, the plurality of pieces of audio data being extracted by moving the time period by a predetermined unit time,
estimate respective feature amounts indicating an emotion of the user from each of the plurality of pieces of audio data, by using an estimation model obtained by executing machine learning for estimating feature amounts indicating an emotion of the user from the plurality of pieces of audio data that have been extracted, and
determine the emotion of the user indicated by the one piece of audio data, by using the respective feature amounts corresponding to the plurality of pieces of audio data.

2. The information processing device according to claim 1, wherein the predetermined time period is set according to, in the one piece of audio data that has been previously acquired:
feature amounts indicating an emotion that corresponds to an emotion of the user that has been set as a label of the one piece of audio data, and
feature amounts indicating an emotion that is different from the emotion of the user that has been set as the label of the one piece of audio data.

3. The information processing device according to claim 1, wherein the processor is configured to extract the plurality of pieces of audio data by setting the unit time, such that a number of pieces of the audio data extracted from the one piece of audio data is a predetermined number.

4. The information processing device according to claim 1, wherein the processor is configured to:
estimate the respective feature amounts indicating the emotion of the user, using, as the estimation model, an individual user estimation model obtained by learning one piece of audio data for each individual user among a plurality of users, and an overall user estimation model obtained by learning one piece of audio data related to all of the plurality of users, and
determine the emotion of the user indicated by the one piece of audio data, using feature amounts that have respectively been estimated by the individual user estimation model and the overall user estimation model.

5. A non-transitory computer-readable medium storing an information processing program that is executable by a computer to perform processing comprising:
acquiring one piece of audio data of a user,
extracting a plurality of pieces of audio data that have been extracted during a predetermined time period from the one piece of audio data, the plurality of pieces of audio data being extracted by moving the time period by a predetermined unit time,
estimate respective feature amounts indicating an emotion of the user from each of the plurality of pieces of audio data, by using an estimation model obtained by executing machine learning for estimating feature amounts indicating an emotion of the user from the plurality of pieces of audio data that have been extracted, and
determine the emotion of the user indicated by the one piece of audio data, by using the respective feature amounts corresponding to the plurality of pieces of audio data.
